(19) United States
(12) Patent Application Publication
(10) Pub. No.: US 2024/0315230 A1
(43) Pub. Date: Sep. 26, 2024

(54) SPRAYER PERFORMANCE MODIFICATION BY HMI

(71) Applicant: BASF AGRO TRADEMARKS GMBH, Ludwigshafen (DE)

(72) Inventors: Carvin Guenther SCHEEL, Koeln (DE); Holger HOFFMANN, Koeln (DE); Clemens Christian DELATREE, Muenster (DE); Enzo Marcel GAUER, Koeln (DE); Steffen TELGMANN, Koeln (DE); Janis Joshua FALTMANN, Koeln (DE)

(21) Appl. No.: 18/698,203

(22) PCT Filed: Oct. 11, 2022
(86) PCT No.: PCT/EP2022/078189

§ 371 Date: Apr. 3, 2024

(30) Foreign Application Priority Data
Oct. 11, 2021 (EP) 21202023.4

(51) Int. Cl. A01M 7/00

(52) U.S. Cl. CPC A01M 7/0089

(57) ABSTRACT

A method for modifying a treatment performance for treating an agricultural field by an agricultural machine, whereas the method comprises a modification function and the agricultural machine comprises at least one treatment component, characterized in that the method having the steps of —Obtaining field data (S1, S10); —Determining a treatment performance by analyzing the field data (S2, S12); —Providing a treatment performance modification via the modification function and a representation parameter (S3, S13); —Modifying the treatment performance with the treatment performance modification (S4, S15).

### TECHNICAL FIELD

The present disclosure relates to a computer-implemented method modifying a treatment performance for treating an agricultural field by an agricultural machine, whereas the method comprises a modification function and the agricultural machine comprises at least one treatment component.

### TECHNICAL BACKGROUND

The general background of this disclosure is the treatment of plants in an agricultural area, which may be an agricultural field, a greenhouse, or the like. The treatment of plants, such as the cultivated crops, may also comprise the treatment of weed present in the agricultural area, the treatment of the insects present in the agricultural area or the treatment of pathogens present in the agricultural area.

When working with an agronomic decision engine (ADE), wrong or not optimized decisions can be obtained without human intervention. Therefore, as the user should have overall control over the entire treatment process on the agricultural field, there is the lack of the method which allows simple, straightforward human intervention or human confirmation in case some unplanned scenarios (e.g. while the agricultural machine moves or moves through the field, it has been detected in real-time that there is much more weed then expected, or that there is another weed species than expected) are occurring on the agricultural field.

### SUMMARY OF THE INVENTION

In one aspect of the present disclosure a computer-implemented method for modifying a treatment performance for treating an agricultural field is disclosed, having the steps of
Obtaining field data;
Determining a treatment performance by analyzing the field data;
Providing a treatment performance modification via the modification function and a representation parameter;
Modifying the treatment performance with the treatment performance modification.

In this way, the treatment performance after analyzing the field data can be varied. When varied within a relatively small region, the resulting performance data and the agricultural effects may be useful for further applications such as optimizing an ADE.

In another embodiment the method comprises additionally the step of generating control data based on the modified treatment performance.

Additionally, the control data can relate to a location-specific on/off-operation of at least one treatment component of the agricultural machine.

In a further embodiment, the method comprises step of controlling the agricultural machine and/or at least one treatment component based on the control data.

In an even further embodiment, the method additionally comprises the steps of
obtaining identity data connected with a farmer of the agricultural field from a database; and
storing or updating the identity data of the database with the treatment performance modification.

Furthermore the determined treatment performance can be based on at least one threshold level.

In the context of the present invention, the term “threshold” (except in case of “treatment performance difference threshold value”) can be understood as follows: For instance, in weed treatment, the threshold may relate to a fraction of weed objects present on an image. For insect treatment the threshold may relate to a fraction of insects present on the image. For disease treatment the threshold may relate to a fraction of fungal infestation present on the image. Here the fraction of pixels associated with weed, insect or fungal infestation may be derived from the image. For a percentage parameter the fraction of pixels associated with weeds, insects or fungal infestation may be related to all pixels or pixels not associated with weed, insect or fungal infestation. In operation of the treatment device, this may be calculated e.g. by the number of pixels assigned to weeds, insects, fungal infestation compared to the total number of pixels of the image. If the fraction is greater than or equals the threshold, an operation mode, such as an on-signal for the treatment component, may be triggered.

In the context of the present invention, the term “threshold” (except in case of “treatment performance difference threshold value”) can be also understood as follows: For instance, in weed treatment the threshold may relate to an area (e.g. in cm² or mm²) of weed objects present on an image compared to a reference area (e.g. an 1 meter×1 meter sub-field zone). For insect treatment the threshold may relate to an area (e.g. in cm² or mm²) of insect objects present on an image compared to a reference area (e.g. an 1 meter×1 meter sub-field zone). to an area (e.g. in cm² or mm²) of fungal infestation objects present on an image compared to a reference area (e.g. an 1 meter×1 meter sub-field zone). In operation of the treatment device, this may be calculated e.g. by the area assigned to weeds, insects, fungal infestation compared to the total reference area. If this percentage is greater than or equals the threshold, an operation mode, such as an on-signal for the treatment component, may be triggered.

Even further a form of the representation parameter is inputted via a HMI device.

Additionally, the treatment performance can be outputted via the HMI device before the form of a representation parameter is inputted via the HMI device.

The term “harmful organism” is understood to be any organism which has a negative impact to the growth or to the health of the agricultural crop plant. Preferably, the harmful organism is selected from the group consisting of weeds, fungi, viruses, bacteria, insects, arachnids, nematodes, mollusks, birds, and rodents, more preferably, the harmful organism is selected from the group consisting of weeds, fungi, insects, arachnids, and nematodes.

Most preferably, the harmful organism is weed.

In a preferred embodiment, the treatment performance can be calculated by analyzing the sensor data taken from the agricultural field, preferably images in which the harmful organism—such as weeds—can be recognized. The sensor data are preferably camera image data.

Additionally, a computer program or computer readable non-volatile storage medium comprising computer readable instructions, which when loaded and executed by a computing unit to perform the methods above are disclosed.

Furthermore, a control system for an agricultural machine, which, when receiving control data according, controls the agricultural machine to perform the methods above, is disclosed.

Additionally, an agricultural machine comprising such a control system and performing the methods above is disclosed.

Any disclosure and embodiments described herein relate to the methods, the systems, the treatment devices, the computer program element lined out above and vice versa.

Advantageously, the benefits provided by any of the embodiments and examples equally apply to all other embodiments and examples and vice versa.

In the context of the present invention, the term “field” or “agricultural field” is understood to be any area in which crop plants, are produced, grown, sown, and/or planned to be produced, grown or sown. The term “field” or “agricultural field” may also include horticultural fields, and silvicultural fields.

In the context of the present invention, the term “treatment” is understood to be any kind of treatment possible in an agricultural field, including but not limited to seeding, fertilization, crop protection, growth regulation, harvesting, adding or removing of organisms—particularly crop plants —, as well as soil treatment, soil nutrient management, soil nitrogen management, tilling, ploughing, irrigation. In a preferred embodiment of the present invention, treatment is one of the following activities: seeding, fertilization, crop protection, growth regulation, harvesting, adding or removing of organisms—particularly crop plants —, as well as soil treatment, soil nutrient management, soil nitrogen management, tilling, ploughing, irrigation. In another preferred embodiment of the pre-sent invention, invention, treatment is crop protection. In another preferred embodiment of the present invention, treatment is growth regulation. In another preferred embodiment of the present invention, treatment is harvesting.

In the context of the present invention, “move(s) or moving through the field” includes driving, flying, travelling through the field.

In the context of the present invention, the “treatment device” may be part of a smart farming machinery and may preferably be part of a distributed computing system. The treatment device may be a driving, flying or any otherwise moving device configured to travel through or over the agricultural area, e.g. via a ground vehicle, a rail vehicle, an aircraft, a drone, or the like. Further, the smart farming machinery or the treatment device may include, for example, a vehicle, an aircraft, a robot, a sprayer, or the like, with one or more treatment mechanisms attached and may comprise a communication and/or connectivity system. The connectivity system may be configured to communicatively couple the smart farming machinery or treatment device to the distributed computing environment.

It may be configured to provide a control file or control data generated via remote computing resources of the distributed computing system to the smart machinery or treatment device or to provide data collected on the smart machinery or treatment device to one or more remote computing resources of the distributed computing system.

A human-machine interface (HMI) device comprises at least an output component, for example a display, for outputting information to a user, and an input component, for inputting information to a computing means. The HMI may comprise at least one display device and/or at least one audio device. The display device may be any one or more of: a visual indicator or a display screen. The audio device may be any one or more of: an annunciator or a loudspeaker. Any one or more determinations or results may be communicated for the user via the HMI, for example, the output signal may be provided either directly or indirectly to the HMI. Additionally, the HMI may also be used to communicate any of the one or more signals retrieved from the machine and/or any of the one or more parameters, either visually and/or audibly. Additionally, the HMI may also be used to display the geographical location and/or any relevant parameters related to the computing unit and/or any one or more parameters or values related to the treatment or related to the treatment performance.

The computing means can also be a distributed computing system.

The “control data” may comprise one operation parameter for the agricultural area, more than one operation parameter for different zones of the agricultural area (e.g. for different sub-field zones) or a spatially resolved map of operation parameters for different locations of the agricultural area.

Identity data relates to the identity of the farmer of this agricultural field. This data allows to relate field data and other data, especially treatment performance modification data, with the identity of the farmer. Preferably, identity data is stored in a database for further use.

The field data can comprise information about the country, the region, the soil, the crop, especially about type and amount of crop, the row width of the crop, the harmful organism (for example weed), especially about the type and amount of the harmful organism (for example weed), the weather, the time, the plantation phase, the planned treatment as well as predictions for such information and about such information gathered in the past.

The agricultural machine either has a treatment map, in which the amount of harmful organism at a given position of the agricultural field is stored, or the agricultural machine is equipped with one or more sensor devices for detecting the amount of harmful organism locally in real-time while moving through the field.

The agricultural machine either has a treatment map, in which the amount of weed at a given position of the agricultural field is stored, or the agricultural machine is equipped with one or more sensor devices for detecting the amount of weed locally in real-time while moving through the field.

From the field data a treatment performance can be derived, especially via an agronomic decision engine (ADE). An ADE connects agronomic relevant input data, in particular historic, current and predicted data, for example from an agricultural field, from an agricultural machine and/or weather data, with an agronomic decision to be taken, especially when, where and how to apply a treatment. The treatment performance can be realized for example in form of one or more threshold values or a substantially continuous or stepwise function.

The treatment performance modification is either positive, negative, or zero, defined by a representation parameter. The modification is preferably a function of a treatment performance, but can also be a fixed value. The modification function can be predefined, can be part of the field data or generated or provided together with the treatment performance.

For example, the modification function can be a fixed percentage of the treatment performance, i.e. 1% or 10%, multiplied by the representation parameter and then applied to the treatment performance.

In another preferred embodiment, the treatment performance modification via HMI is conducted in real time, particularly while moving through the field.

In another preferred embodiment, the following method (also referred to as “real-time treatment performance modification via HMI”) has been found: A method for modifying a treatment performance for treating an agricultural field by an agricultural machine, whereas the method comprises a modification function and the agricultural machine comprises at least one treatment component, characterized in that the method having the steps of
Obtaining field data (S1, S10) of the agricultural field in real-time while the agricultural machine moves through the agricultural field, wherein the field data at least comprises information about the presence of harmful organism on the field;
Determining a treatment performance by analyzing the field data (S2, S12) in real-time while the agricultural machine moves through the agricultural field;
Providing a treatment performance modification via the modification function and a representation parameter in real-time while the agricultural machine moves through the agricultural field (S3, S13);
Modifying the treatment performance with the treatment performance modification in real-time while the agricultural machine moves through the agricultural field (S4, S15), preferably by inputting a form of the representation parameter via an HMI device (S14).

In another preferred embodiment, the following method (also referred to as “real-time treatment performance modification via HMI on sub-field zone level”) has been found: A method for modifying a treatment performance for treating an agricultural field by an agricultural machine, whereas the method comprises a modification function and the agricultural machine comprises at least one treatment component, characterized in that the method having the steps of
Obtaining field data (S1, S10) of a sub-field zone of the agricultural field in real-time while the agricultural machine moves through the sub-field zone, wherein the field data at least comprises information about the presence of harmful organism on the field;
Determining a treatment performance for the sub-field zone by analyzing the field data (S2, S12) in real-time while the agricultural machine moves through the sub-field zone;
Providing a treatment performance modification for the sub-field zone via the modification function and a representation parameter in real-time while the agricultural machine moves through the sub-field zone (S3, S13);
Modifying the treatment performance for the sub-field zone with the treatment performance modification in real-time while the agricultural machine moves through the sub-field zone—(S4, S15), preferably by inputting a form of the representation parameter via an HMI device (S14).

In another preferred embodiment, the following method (also referred to as “real-time treatment performance modification via HMI on sub-field zone level with a triggering signal”) has been found:

A method for modifying a treatment performance for treating an agricultural field by an agricultural machine, whereas the method comprises a modification function and the agricultural machine comprises at least one treatment component, characterized in that the method having the steps of
Obtaining field data (S1, S10) of a sub-field zone of the agricultural field in real-time while the agricultural machine moves through the sub-field zone, wherein the field data at least comprises information about the presence of harmful organism on the field;
Determining a treatment performance for the sub-field zone by analyzing the field data (S2, S12) in real-time while the agricultural machine moves through the sub-field zone;
Providing a treatment performance modification for the sub-field zone via the modification function and a representation parameter in real-time while the agricultural machine moves through the sub-field zone (S3, S13);
Calculating a difference between the planned treatment performance for the sub-field zone and the determined treatment performance for the sub-field zone, and based on this calculated difference or depending on whether this calculated difference exceeds a predetermined treatment performance difference threshold value, generating an adjustment signal to the HMI device (S3.6, S13.6),
Modifying the treatment performance for the sub-field zone with the treatment performance modification in real-time while the agricultural machine moves through the sub-field zone based on the adjustment signal—(S4, S15), preferably by inputting a form of the representation parameter via an HMI device (S14).

In a preferred embodiment, the method comprises the following step (S3.6, S13.6):
Calculating a difference between the planned treatment performance for the sub-field zone and the determined treatment performance for the sub-field zone, and based on this calculated difference or depending on whether this calculated difference exceeds a predetermined treatment performance difference threshold value, generating an adjustment signal to the HMI device (S3.6, S13.6).

In a preferred embodiment, the method comprises the following step (S3.6, S13.6): Calculating a difference between the planned treatment performance for the sub-field zone and the determined treatment performance for the sub-field zone, and based on this calculated difference or depending on whether this calculated difference exceeds a predetermined treatment performance difference threshold value, generating an adjustment signal to the HMI device (S3.6, S13.6), and the step “Modifying the treatment performance” (S4, S15) comprises: Modifying the treatment performance for the sub-field zone with the treatment performance modification in real-time while the agricultural machine moves through the sub-field zone based on the adjustment signal—(S4, S15), preferably by inputting a form of the representation parameter via an HMI device (S14).

Preferably, the entire process starting from “obtaining field data” (step S1, S10) and ending with “modifying the treatment performance” (step S4, S14) is conducted in real-time, i.e. that preferably not more than 15 minutes, more preferably not more than 10 minutes, most preferably not more than 5 minutes, particularly preferably not more than 2 minutes, particularly more preferably not more than 60 seconds, particularly most preferably not more than 30 seconds, particularly not more than 15 seconds, particularly for example not more than 5 seconds, for example not more than 2 seconds lies between the “obtaining field data” (step S1, S10) and the “modifying the treatment performance” (step S4, S14).

In the context of the present invention, the term “zone” or “sub-field zone” is understood to be a zone or a part of an agricultural field, i.e. an agricultural field can be spatially divided into more than one zone, wherein each zone may have different properties such as different biomass levels or different weed and/or pathogen infestation risks. A sub-field zone can be preferably a 0.1 m×0.1 m zone, a 0.5 m×0.5 m zone, a 1 m×1 m zone, a 2 m×2 m zone, a 3 m×3 m zone, a 5 m×5 m zone, a 10 m×10 m zone, a 20 m×20 m zone, a 30 m×30 m zone, or a 50 m×50 m zone.

In the context of the present invention, the term “real-time” means that a second process—for example the obtaining of field data of a sub-field zone—is being performed within a very short time period, preferably not more than 15 minutes, more preferably not more than 10 minutes, most preferably not more than 5 minutes, particularly preferably not more than 2 minutes, particularly more preferably not more than 60 seconds, particularly most preferably not more than 30 seconds, particularly not more than 15 seconds, particularly for example not more than 5 seconds, for example not more than 2 seconds, after a first process—for example moving through the same sub-field zone by an agricultural machine—is being performed.

In the context of the present invention, the term “treatment performance” is understood to be the expected percentage of harmful organism (e.g. weed) which can be removed or repelled by the treatment. In the context of the present invention, the term “planned treatment performance” is the treatment performance which has been calculated prior to the start of the treatment, particularly at the time when the treatment has been planned.

In a preferred embodiment, the treatment performance is dependent on the type and dose rate of the treatment product (including but not limited to herbicides, fungicides, insecticides, acaricides, nematicides, rodenticides etc.) applied. In another preferred embodiment, the treatment performance is dependent on the threshold (harmful organism threshold, for example weed threshold). In another preferred embodiment, the treatment performance is dependent on the harmful organism (including type, species, biological or genetic variant) to be treated.

Preferably, the treatment performance is determined or updated for a sub-field zone by analyzing the field data in real-time—e.g. every 15 minutes, every 5 minutes, every 2 minutes, every 60 seconds, every 30 seconds, every 15 seconds, every 5 seconds or every 2 seconds—while the agricultural machine moves through the sub-field zone. For example (example 1), if—according to the analysis of the field data (which are preferably taken in real-time from sensors such as cameras)—the harmful organism in a specific sub-field zone is present in a higher density or percentage or in a later/larger growth stage then expected or planned prior to the treatment, the determined treatment performance will be most likely lower than the planned treatment performance, i.e. there will be a calculated difference between the determined treatment performance and the planned treatment performance which will be most likely negative (minus). In another example (example 2), if—according to the analysis of the field data (which are preferably taken in real-time from sensors such as cameras)—the harmful organism in a specific sub-field zone is present in a lower density or percentage or in an earlier/smaller growth stage than expected or planned prior to the treatment, the determined treatment performance will be most likely higher than the planned treatment performance, i.e. there will be a calculated difference between the determined treatment performance and the planned treatment performance which will be most likely positive (plus). In another example (example 3), if—according to the analysis of the field data (which are preferably taken in real-time from sensors such as cameras)—the harmful organism in a specific sub-field zone is present as another species or biological variant or genetic variant than expected or planned prior to the treatment, the determined treatment performance will be most likely lower than the planned treatment performance, i.e. there will be a calculated difference between the determined treatment performance and the planned treatment performance which will be most likely negative (minus). In another example (example 4), if—according to the analysis of the field data (which are preferably taken in real-time from sensors such as cameras)—the harmful organism in a specific sub-field zone is present in another form or with another characteristic than expected or planned prior to the treatment, the determined treatment performance will be most likely lower or higher than the planned treatment performance, i.e. there will be a calculated difference between the determined treatment performance and the planned treatment performance which will be most likely negative (minus) or positive (plus).

Particularly, in all these three examples 1 to 4, depending on whether this calculated difference exceeds a predetermined treatment performance difference threshold value, an adjustment signal to the HMI device will be generated. The adjustment signal could be in the form of: “No modification recommended” (especially in the event that this calculated difference has not exceeded a predetermined treatment performance difference threshold value), “modification recommended” (especially in the event that this calculated difference has exceeded a predetermined treatment performance difference threshold value), “modification of the weed threshold or harmful organism threshold of plus or minus x % recommended” (especially in the event that this calculated difference has not exceeded a predetermined treatment performance difference threshold value). On the HMI device, the treatment performance modification can be conducted by inputting a form of an inputting a form of the representation parameter via an HMI device, or by accepting the modifications recommended in the adjustment signal via the HMI device. In another preferred embodiment, the user can predetermine in the settings on the HMI device that, in case a certain adjustment signal to the HMI device is generated, in all cases the treatment performance modification will be conducted according to the recommended modifications of the adjustment signal.

Preferably, the adjustment signal is a control file or control data. More preferably, the adjustment signal is transmitted via a push notification or push message (e.g. push SMS or push e-mail) to the HMI device.

Preferably, the representation parameter can be +1, −1 and 0. More preferably, the representation parameter “+1” will cause an increase of the weed threshold or harmful organism threshold at a given magnitude or range, the representation parameter “−1” will cause a decrease of the weed threshold or harmful organism threshold at a given magnitude or range, and the representation parameter “0” will not cause any change of the weed threshold or harmful organism threshold. In another preferred embodiment, the representation parameter can be any numeric value, which can be set by the user via the HMI device, for example via a slider (linear slider or circular slider), or via a numeric value input.

The invention can be exemplarily described by the following illustrative example no. 1: Illustrative example no. 1:

The agricultural field comprises 2 sub-field zones Z1, and Z2. 2 days prior to the treatment of the agricultural field, the following weeds have been detected:
In sub-field zone Z1: Weed species W1 with a coverage of approx. 0.1% (i.e. the percentage of the weed area compared to the total area is 0.1%) has been detected;
In the sub-field zone Z2: Weed species W2 with a coverage of approx. 0.02% has been detected:

The planned treatment performance (2 days prior to the treatment) was as follows:
For sub-field zone Z1: Estimated 90% (since a herbicide with high efficacy is applied) at the W1-specific weed threshold of 0.05% (i.e. if W1 coverage of approx. 0.05% is reached, then the treatment will be conducted)
For sub-field zone Z2: Estimated 80% (since a herbicide with relatively high efficacy is applied) at the W2-specific weed threshold of 0.015% (i.e. only if W2 coverage of approx. 0.015% is reached, then the treatment will be conducted)

On the day of the treatment, then the agricultural machine comprising the spraying device is moving through the field and conducting the treatment, the following deviations have been detected by the sensor (which obtains the field data) which is attached or communicatively to the agricultural machine:
When the agricultural machine has moved through the first 5% area part of the sub-field zone Z1, it has been detected through the obtained field data in real-time that everything is normal, that there are no deviations. Therefore, the expected treatment performance equals the planned treatment performance, nothing needs to be modified.
When the agricultural machine has moved through the first 5% area part of the sub-field zone Z2: It has been detected through the obtained field data in real-time that not the normal rather harmless biological or genetic variant of W2 is present, but an extremely aggressive harmful biological or genetic variant of W2 is present. If the weed threshold is kept at 0.015%, in some parts of Z2, W2 will be still present after treatment. The expected treatment performance is determined to be only 50%, thus minus 30% compared to the planned treatment performance. These minus 30% exceeds the predetermined treatment performance threshold value of 10%. Now, the treatment performance modification is provided in real-time, and an adjustment signal is generated to the HMI device in real-time, containing the recommendation for sub-field zone “Recommend to lower W2-specific weed threshold from 0.015% to 0.001%”.
Depending on the user-predetermined settings on the HMI device, two different actions can take place:
   a) If the user has predetermined the setting that all recommendations from the adjustment signal should be automatically accepted, then the treatment performance will be modified according to the recommendation “Recommend to lower W2-specific weed threshold from 0.015% to 0.001%)”, at the representation parameter being for example “−1”. Accordingly, the control data usable for controlling the agricultural machine based on the modified treatment performance will be generated in real-time for sub-field zone Z2. That means, when the machine moves through the remaining 95% area part of the sub-field zone Z2, the weed threshold has been now adjusted to 0.001%.
   b) If the user has predetermined the setting that all recommendations from the adjustment signal should not be automatically accepted, than he has to actively provide an input in the HMI device that he wants to accept the recommended modifications according to the adjustment signal, by for example clicking on a “confirm” button or on a “−1” button (at the representation parameter being for example “−1”, i.e. meaning that the recommended lowering should be conducted 1:1, i.e. at 100%). Accordingly, the control data usable for controlling the agricultural machine based on the modified treatment performance will be generated in real-time for sub-field zone Z2. That means, when the machine moves through the remaining 95% area part of the sub-field zone Z2, the weed threshold has been now adjusted to 0.001%.

### BRIEF DESCRIPTION OF THE DRAWINGS

Exemplary embodiments will be described in the following with reference to the following drawings:

FIG. 1 illustrates an example embodiment of a general overview of a distributed computing system according to the present invention;

FIG. 2 shows an exemplary embodiment of a method for modifying a treatment performance for treating an agricultural field by an agricultural machine;

FIG. 3 shows another exemplary embodiment of a method for modifying a treatment performance for treating an agricultural field by an agricultural machine.

### DETAILED DESCRIPTION OF EMBODIMENTS

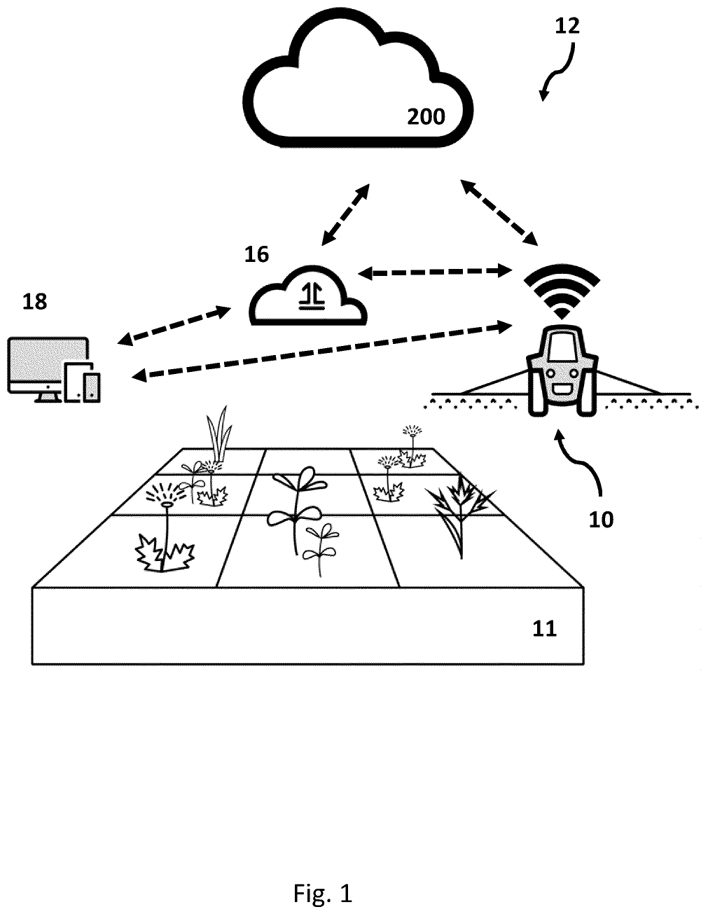

FIG. 1 shows a general overview of a distributed computing system 12 including an agricultural machine 10 and a system 200. The distributed computing system 12 is configured for treatment of a field 11 with crops cultivated. The field 11 may to be treated by use of a treatment product, e.g. an herbicide, pesticide, insecticide, fungicide, or the like. Further, the field 11, may be any plant or crop cultivation area, such as a field, a greenhouse, or the like, at a geo-referenced location. As indicated in FIG. 1 by interlines, the field 11 may optionally be divided into two or more subareas illustrating zone-specific or location specific specificity.

The system 12 may form a distributed computing environment. It may comprise one or more of an agricultural machine 10, a first computing resource or means or system 200, a second computing resource or means 16, and a third computing resource or means 18. The agricultural machine 10 and/or the first, second and third computing means 200, 16, 18, may at least partly be remote to each other.

At least some of the agricultural machine 10 and the first, the second and the third computing means 200, 16, 18 may comprise one or more of a data processing unit, a memory, a data interface, a communication interface, etc. Within the system 12, the agricultural machine 10 and the first, the second and the third computing means 200, 16, 18 may be configured to communicate with each other via communication means, such as a communications network, as indicated in FIG. 1 by dashed lines between the entities 10, 200, 16 and 18.

The agricultural machine 10 may also be referred to as a smart farming machinery. The agricultural machine 10 may be e.g. a vehicle, such as a tractor or the like, an aircraft, a robot, a smart sprayer, or the like, and may be configured to be operated, for example, computer-aided, by a remote control and/or at least semi-autonomous. The agricultural machine 10 may, for example, comprise and/or carry a treatment component, which may be e.g. a spraying device for application of a treatment product.

The first computing means or system 200 may be a farm management system configured to generate and/or provide for sustainability tracking of a treatment device 10 for treating an agricultural field 11 with a treatment product.

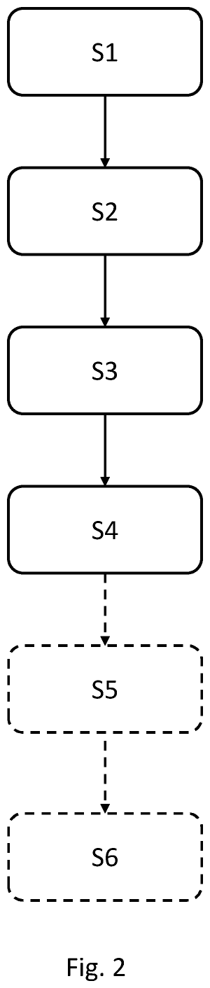

In FIG. 2 an exemplary embodiment of the method for modifying a treatment performance for treating an agricultural field by an agricultural machine, here for treating weed by spraying a herbicide, is depicted. In this exemplary embodiment, the farmer of the agricultural field inputs field data to a computing unit via a HMI device S1. The field data might comprise data acquired by a sensor device. From analyzing the field data, a treatment performance in form of a threshold value is determined S2. The treatment is to be performed by an agricultural machine if the amount of weed stored in a treatment map or detected on the field exceeds locally the threshold value.

A modification function is provided and the farmer inputs a form of a representation parameter via the HMI device S3, the representation parameter (r) denoting one of +1, −1 or 0. In this embodiment, the threshold value is a number between 0 (keeping the treatment always active) and 1 (no treatment is performed) and the treatment performance modification (tpm) is the representation (r) of +1, −1 or 0 multiplied by the modification function, here by 10% of the absolute of one minus the threshold value (tv): tpm=r*0.1*(∥1-tv∥).

The generated threshold value is then modified by the treatment performance modification S4.

The modified threshold value can then be optionally used to generate control data for the agricultural machine S5. When transferred to the agricultural machine, the agricultural machine can be controlled to perform the treatment of the agricultural field according to the modified threshold value S6.

The treatment performance modification or parts of it can also be uploaded to a database and stored within or updating data, in particular in relation with the identity of the farmer, the field data and/or the threshold value.

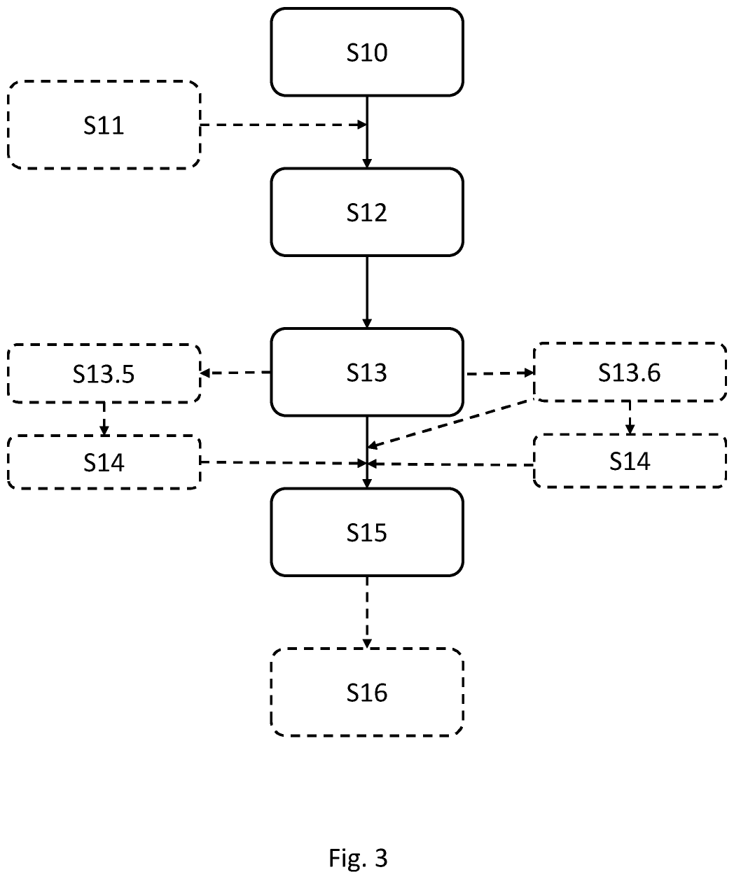

In FIG. 3, another exemplary embodiment of the for modifying a treatment performance for treating an agricultural field by an agricultural machine, also here for treating weed by spraying a herbicide, is depicted. Here, identity data is loaded from a database S10, comprising the farmers identity and field data. The data can also be updated by the farmer via the HMI device S11.

From analyzing the field data, a treatment performance in form of a threshold value is determined S12. The treatment is to be performed by an agricultural machine if the amount of weed stored in a treatment map or detected on the field exceeds locally the threshold value.

A modification function is provided and the farmer inputs a form of a representation parameter via the HMI device S13, the representation parameter (r) denoting one of +1, −1 or 0.

The treatment performance here generated is an essentially continuous or a stepwise function, connecting the amount of weed, for example normalized between 0 and 1, to an amount of treatment, in particular a treatment product, from a treatment component of the agricultural machine to be applied, also normalized between 0 (no treatment, especially no activation of the treatment component) and 1 (full treatment, full activation of the treatment component). The treatment performance modification (tpm) here can be for example the representation parameter (r) of +1, −1 or 0 multiplied by 5% of the treatment performance (tp): tpmpr*0.05*tp, Part of the treatment performance modification, especially the representation parameter (r), can be loaded from the identity data stored in the database. The representation (r) can also be changed by the farmer via the HMI device S14.

The treatment performance is then modified by the treatment performance modification S15, whereas here the modified treatment performance is capped between 0 and 1.

The modified treatment performance can then be used to generate control data for the agricultural machine. When transferred to the agricultural machine, the agricultural machine performs the treatment of the agricultural field according to the modified treatment performance (especially the modified weed threshold or harmful organism threshold).

The treatment performance modification or parts of it can also be uploaded to a database and stored within or updating data, in particular in relation with the identity of the farmer, the field data and/or the treatment performance S16.

Additionally, the treatment performance might be provided via a HMI device to the farmer before he inputs the representation of the treatment performance modification via the HMI device S13.5.

Additionally, a difference between the planned treatment performance for the sub-field zone and the determined treatment performance for the sub-field zone might be calculated, and based on this calculated difference or depending on whether this calculated difference exceeds a predetermined treatment performance difference threshold value, an adjustment signal to the HMI device is generated (S13.6).

The present disclosure has been described in conjunction with a preferred embodiment as examples as well. However, other variations can be understood and effected by those persons skilled in the art and practicing the claimed invention, from the studies of the drawings, this disclosure and the claims.

Notably, in particular, the any steps presented can be performed in any order, i.e. the present invention is not limited to a specific order of these steps. Moreover, it is also not required that the different steps are performed at a certain place or at one node of a distributed system, i.e. each of the steps may be performed at a different nodes using different equipment/data processing units.

In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

1. A method for modifying a treatment performance for treating an agricultural field by an agricultural machine, wherein the method comprises a modification function and the agricultural machine comprises at least one treatment component, the method comprising:
obtaining field data (S1, S10);
determining a treatment performance by analyzing the field data (S2, S12);
providing a treatment performance modification via the modification function and a representation parameter (S3, S13); and
modifying the treatment performance with the treatment performance modification (S4, S15).

2. A method for modifying a treatment performance for treating an agricultural field by an agricultural machine, wherein the method comprises a modification function and the agricultural machine comprises at least one treatment component, the method comprising:
obtaining field data (S1, S10) of the agricultural field in real-time while the agricultural machine moves through the agricultural field, wherein the field data at least comprises information about the presence of harmful organism on the field;
determining a treatment performance by analyzing the field data (S2, S12) in real-time while the agricultural machine moves through the agricultural field;
providing a treatment performance modification via the modification function and a representation parameter in real-time while the agricultural machine moves through the agricultural field (S3, S13); and
modifying the treatment performance with the treatment performance modification in real-time while the agricultural machine moves through the agricultural field (S4, S15).

3. A method for modifying a treatment performance for treating an agricultural field by an agricultural machine, wherein the method comprises a modification function and the agricultural machine comprises at least one treatment component, the method comprising:
obtaining field data (S1, S10) of a sub-field zone of the agricultural field in real-time while the agricultural machine moves through the sub-field zone, wherein the field data at least comprises information about the presence of harmful organism on the field;
determining a treatment performance for the sub-field zone by analyzing the field data (S2, S12) in real-time while the agricultural machine moves through the sub-field zone;
providing a treatment performance modification for the sub-field zone via the modification function and a representation parameter in real-time while the agricultural machine moves through the sub-field zone (S3, S13); and
modifying the treatment performance for the sub-field zone with the treatment performance modification in real-time while the agricultural machine moves through the sub-field zone—(S4, S15).

4. The method according to claim 1, further comprising generating control data based on the modified treatment performance (S5).

5. The method according to claim 1, wherein the control data relates to a location-specific on/off-operation of at least one treatment component of the agricultural machine.

6. The method according to claim 1, further comprising controlling the agricultural machine and/or at least one treatment component based on the control data (S6).

7. The method according to claim 1, further comprising:
obtaining identity data connected with a farmer of the agricultural field from a database; and
storing or updating the identity data of the database with the treatment performance modification.

8. The method according to claim 1, wherein the determined treatment performance is based on at least one threshold level.

9. The method according to claim 1, wherein a form of the representation parameter is inputted via a HMI device (S14).

10. The method according to claim 9, wherein the treatment performance is outputted via the HMI device before the form of a representation parameter is inputted via the HMI device (S13.5).

11. The method according to claim 1,
wherein the method further comprises calculating a difference between the planned treatment performance for the sub-field zone and the determined treatment performance for the sub-field zone, and based on this calculated difference or depending on whether this calculated difference exceeds a predetermined treatment performance difference threshold value, generating an adjustment signal to the HMI device (S3.6, S13.6), and
wherein modifying the treatment performance comprises: modifying the treatment performance for the sub-field zone with the treatment performance modification in real-time while the agricultural machine moves through the sub-field zone based on the adjustment signal (S4, S15).

12. The method according to claim 1, wherein obtaining field data and modifying the treatment performance is conducted in real-time.

13. A non-transitory computer readable medium having instructions encoded thereon that, when executed by a computing device, cause the computing device to preform the method of claim 1.

14. A control system for an agricultural machine, which, when receiving control data, causes the agricultural machine to perform the method according to claim 1.

15. An agricultural machine comprising the control system according to claim 14.
